(19) United States
(12) Patent Application Publication
(10) Pub. No.: US 2024/0019671 A1
(43) Pub. Date: Jan. 18, 2024

(54) OPTICAL SYSTEM, IMAGE PICKUP APPARATUS, AND OPTICAL APPARATUS

(71) Applicant: CANON KABUSHIKI KAISHA, Tokyo (JP)

(72) Inventors: Satoshi UMEHARA, Tochigi (JP); Kohei KIMURA, Saitama (JP)

(21) Appl. No.: 18/349,554

(22) Filed: Jul. 10, 2023

(30) Foreign Application Priority Data
Jul. 12, 2022 (JP) 2022-111958

(51) Int. Cl. G02B 15/14; G02B 15/24

(52) U.S. Cl. CPC G02B 15/1461; G02B 15/24

(57) ABSTRACT

An optical system includes, in order from an object side to an image side, first to fourth lens units. A distance changes between adjacent lens units during focusing from infinity to a close distance. The optical system includes an aperture stop disposed on the image side of the second lens unit, a final lens unit, the first lens unit and the final lens unit being fixed relative to the image plane during the focusing, and focus lens units disposed on the object side and the image side of the aperture stop. A focus lens unit closest to the image plane among the focus lens units moves toward the image side during the focusing. The optical system is configured to increase an absolute value of an imaging magnification at a shortest imaging distance to 0.5 times or higher. The final lens unit includes positive and negative lenses. A predetermined condition is satisfied.

### BACKGROUND

### Technical Field

One of the aspects of the embodiments relates generally to an optical system, and more particularly to an optical system suitable for a digital video camera, a digital still camera, a broadcasting camera, a film-based camera, a surveillance camera, and the like.

### Description of Related Art

A macro lens is known as a lens that can provide close-up imaging. The macro lens has recently been demanded to have high optical performance and few aberration fluctuations in the entire focusing area.

Each of Japanese Patent Laid-Open Nos. 2015-57662 and 2019-164277 discloses a macro lens that corrects aberration fluctuations during focusing by moving a large focus lens unit during focusing.

However, in each of the macro lenses described in Japanese Patent Laid-Open Nos. 2015-57662 and 2019-164277, an actuator configured to move the large focus lens unit becomes large, and the large focus lens causes the focusing stop accuracy to deteriorate and the focusing speed to decrease.

### SUMMARY

An optical system according to one aspect of the disclosure includes, in order from an object side to an image side, a first lens unit, a second lens unit, a third lens unit, and a fourth lens unit. Each distance changes between adjacent lens units during focusing from infinity to a close distance. The optical system further includes an aperture stop disposed on the image side of the second lens unit, a final lens unit disposed closest to an image plane in the optical system, the first lens unit and the final lens unit being fixed relative to the image plane during the focusing, and focus lens units disposed on the object side and the image side of the aperture stop and movable during the focusing. A focus lens unit closest to the image plane among the focus lens units moves toward the image side during the focusing. The optical system is configured to increase an absolute value of an imaging magnification at a shortest imaging distance to 0.5 times or higher. The final lens unit includes a positive lens and a negative lens. The following inequality is satisfied:

0.025<dF/L<0.099

where dF is a sum of distances on an optical axis from a lens surface closest to an object to a lens surface closest to the image plane in each of the focus lens units, and L is an overall lens length of the optical system. An image pickup apparatus and an optical system having the above optical system also constitute another aspect of the disclosure.

Further features of the disclosure will become apparent from the following description of embodiments with reference to the attached drawings.

### BRIEF DESCRIPTION OF THE DRAWINGS

FIG. 1 is a sectional view of an optical system according to Example 1.

FIG. 2A is a longitudinal aberration diagram of the optical system according to Example 1 in an in-focus state at infinity, and FIG. 2B is a longitudinal aberration diagram of the optical system according to Example 1 at an imaging magnification of −1.0.

FIG. 3 is a sectional view of an optical system according to Example 2.

FIG. 4A is a longitudinal aberration diagram of the optical system according to Example 2 in an in-focus state at infinity, and FIG. 4B is a longitudinal aberration diagram of the optical system according to Example 2 at an imaging magnification of −1.0.

FIG. 5 is a sectional view of an optical system according to Example 3.

FIG. 6A is a longitudinal aberration diagram of the optical system according to Example 3 in an in-focus state at infinity, and FIG. 6B is a longitudinal aberration diagram of the optical system according to Example 3 at an imaging magnification of −0.5.

FIG. 7 is a sectional view of an optical system according to Example 4.

FIG. 8A is a longitudinal aberration diagram of the optical system according to Example 4 in an in-focus state at infinity, and FIG. 8B is a longitudinal aberration diagram of the optical system according to Example 4 at an imaging magnification of −0.5.

FIG. 9 is a sectional view of an optical system according to Example 5.

FIG. 10A is a longitudinal aberration diagram of the optical system according to Example 5 in an in-focus state at infinity, and FIG. 10B is a longitudinal aberration diagram of the optical system according to Example 5 at an imaging magnification of −1.0.

FIG. 11 is a sectional view of an optical system according to Example 6.

FIG. 12A is a longitudinal aberration diagram of the optical system according to Example 6 in an in-focus state at infinity, and FIG. 12B is a longitudinal aberration diagram of the optical system according to Example 6 at an imaging magnification of −1.0.

FIG. 13 is a sectional view of an optical system according to Example 7.

FIG. 14A is a longitudinal aberration diagram of the optical system according to Example 7 in an in-focus state at infinity, and FIG. 14B is a longitudinal aberration diagram of the optical system according to Example 7 at an imaging magnification of −1.0.

FIG. 15 is a sectional view of an optical system according to Example 8.

FIG. 16A is a longitudinal aberration diagram of the optical system according to Example 8 in an in-focus state at infinity, and FIG. 16B is a longitudinal aberration diagram of the optical system according to Example 8 at an imaging magnification of −1.0.

FIG. 17 is a schematic diagram of an image pickup apparatus.

### DESCRIPTION OF THE EMBODIMENTS

Referring now to the accompanying drawings, a description will be given of an embodiment of an optical system and an image pickup apparatus having the optical system according to the present disclosure.

The optical system according to each example is an optical system that is used in an image pickup apparatus such as a digital video camera, a digital still camera, a broadcasting camera, a film-based camera, and a surveillance camera.

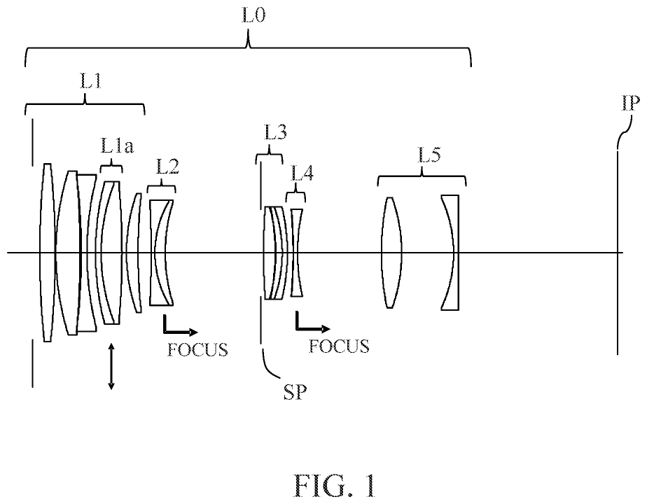

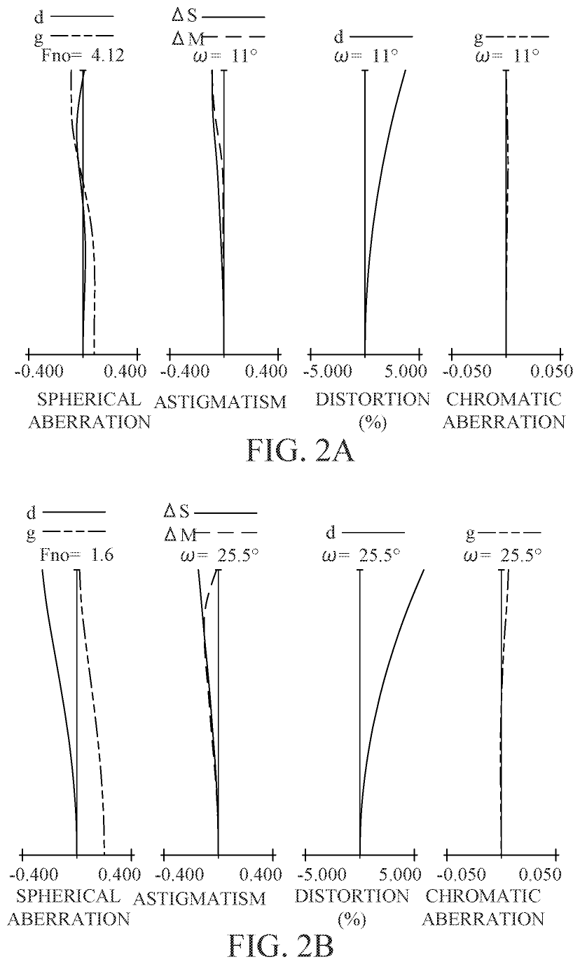

FIG. 1 is a lens sectional view of an optical system L0 according to Example 1 in the in-focus state at infinity. FIG. 2A is a longitudinal aberration diagram of the optical system L0 according to Example 1 in the in-focus state at infinity. FIG. 2B is a longitudinal aberration diagram of the optical system L0 according to Example 1 at an imaging magnification of −1.0. The optical system L0 according to Example 1 is an optical system having an F-number of about four.

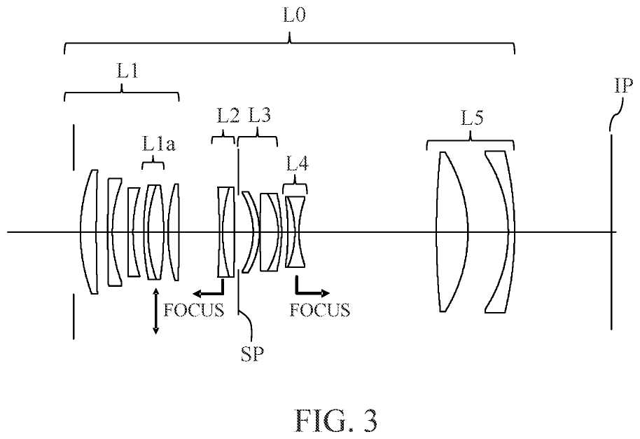

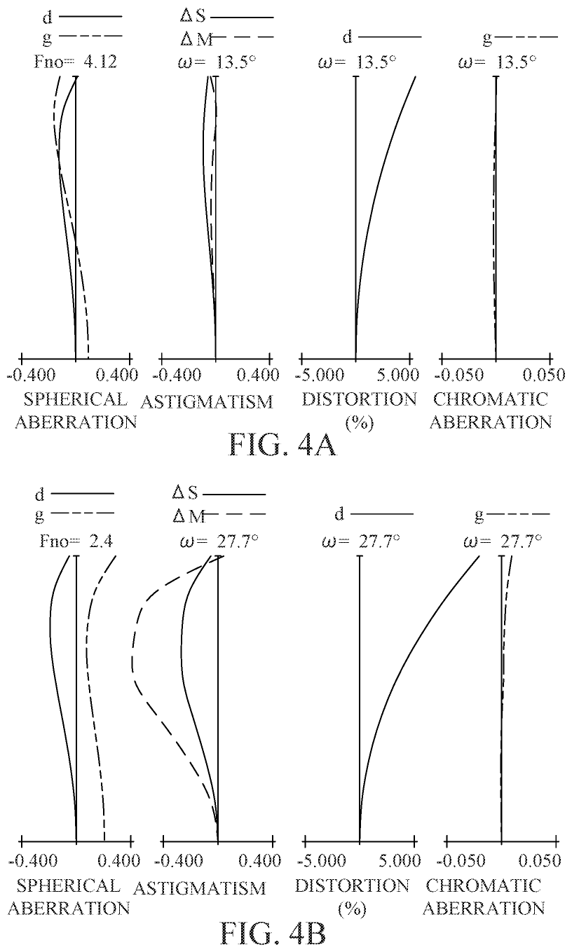

FIG. 3 is a lens sectional view of an optical system L0 according to Example 2 in the in-focus state at infinity. FIG. 4A is a longitudinal aberration diagram of the optical system L0 according to Example 2 in the in-focus state at infinity. FIG. 4B is a longitudinal aberration diagram of the optical system L0 according to Example 2 at an imaging magnification of −1.0. The optical system L0 according to Example 2 is an optical system having an F-number of about four.

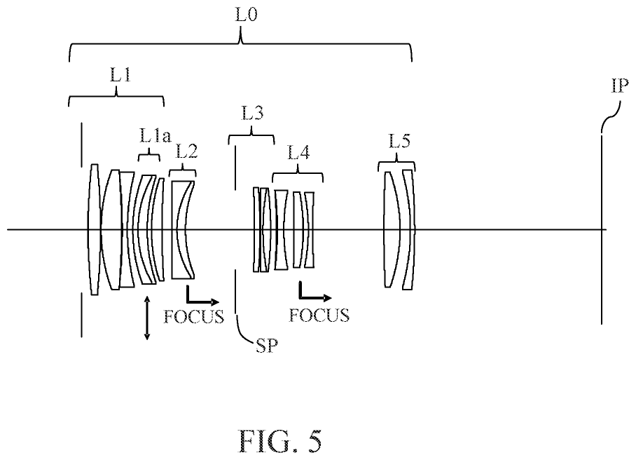

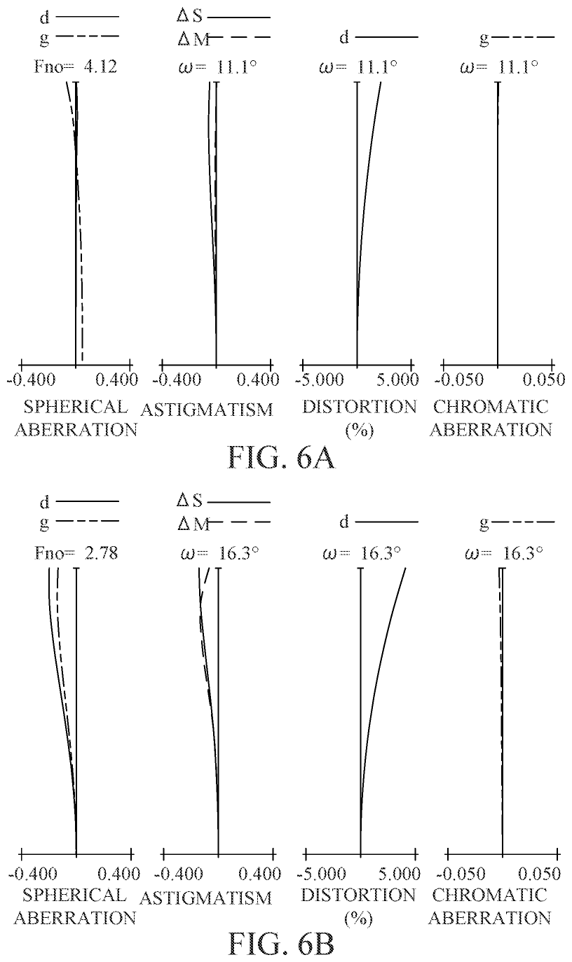

FIG. 5 is a lens sectional view of an optical system L0 according to Example 3 in the in-focus state at infinity. FIG. 6A is a longitudinal aberration diagram of the optical system L0 according to Example 3 in the in-focus state at infinity. FIG. 6B is a longitudinal aberration diagram of the optical system L0 according to Example 3 at an imaging magnification of −0.5. The optical system L0 according to Example 3 is an optical system with an F-number of about four.

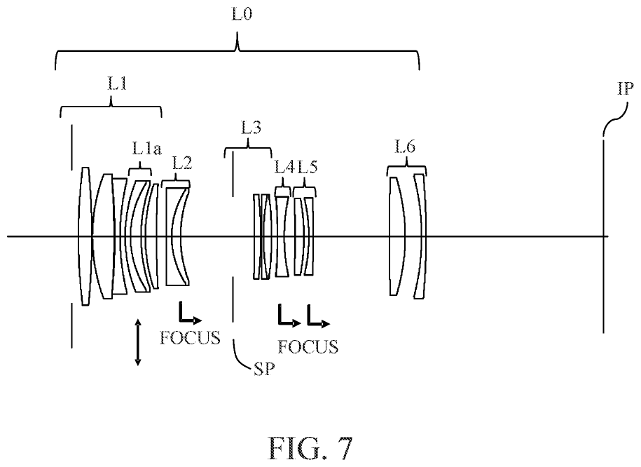

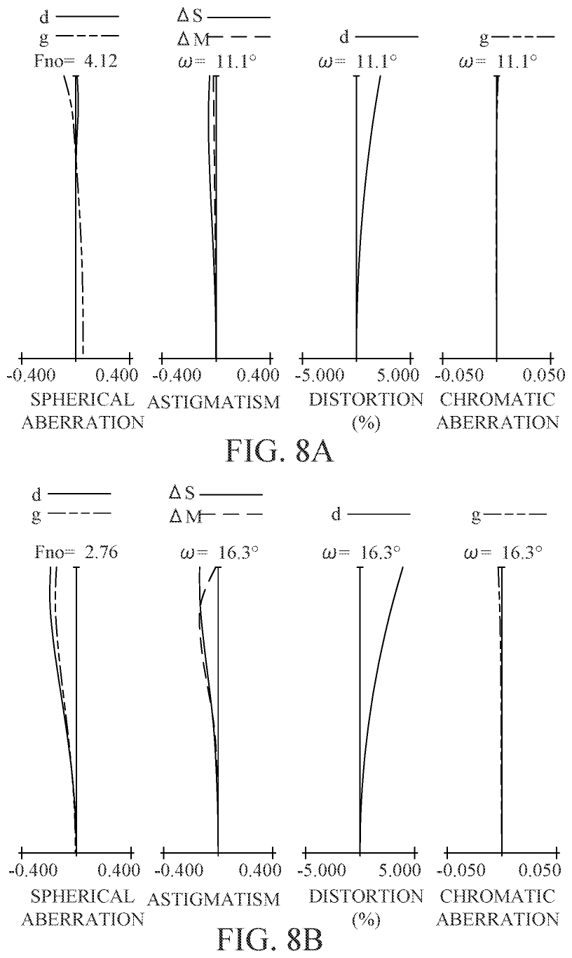

FIG. 7 is a lens sectional view of an optical system L0 according to Example 4 in the in-focus state at infinity. FIG. 8A is a longitudinal aberration diagram of the optical system L0 according to Example 4 in the in-focus state at infinity. FIG. 8B is a longitudinal aberration diagram of the optical system L0 according to Example 4 at an imaging magnification of −0.5. The optical system L0 according to Example 4 is an optical system having an F-number of about four.

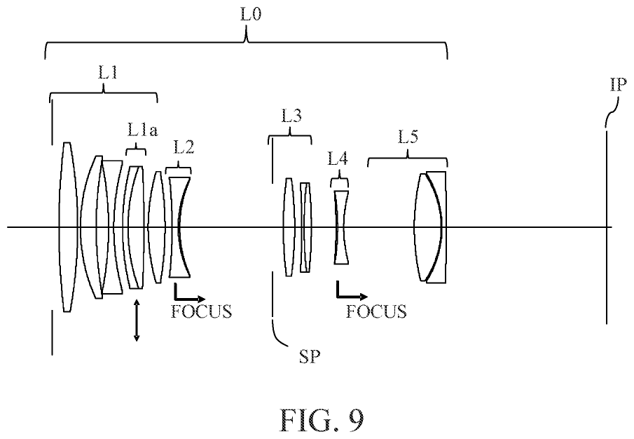

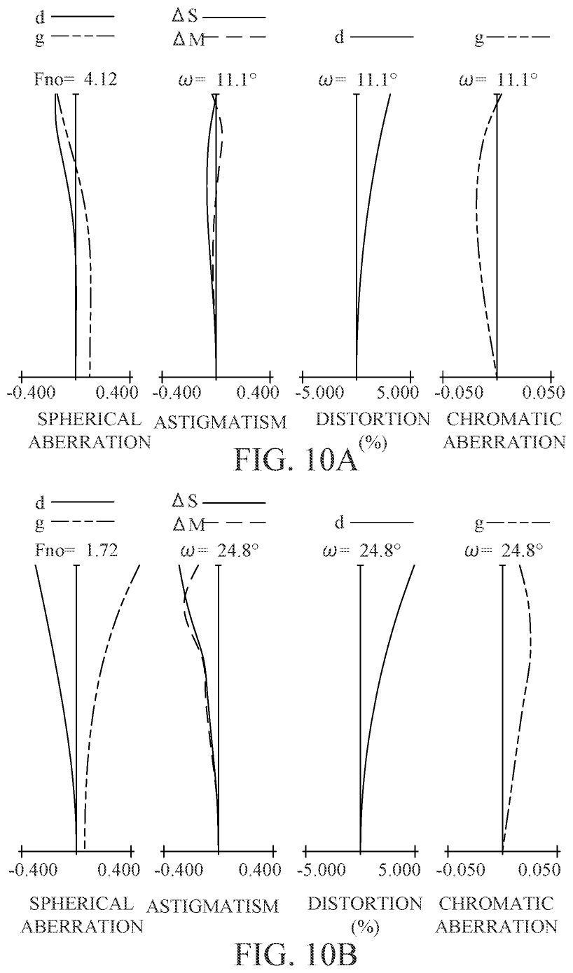

FIG. 9 is a lens sectional view of an optical system L0 according to Example 5 in the in-focus state at infinity. FIG. 10A is a longitudinal aberration diagram of the optical system L0 according to Example 5 in the in-focus state at infinity. FIG. 10B is a longitudinal aberration diagram of the optical system L0 according to Example 5 at an imaging magnification of −1.0. The optical system L0 according to Example 5 is an optical system having an F-number of about four.

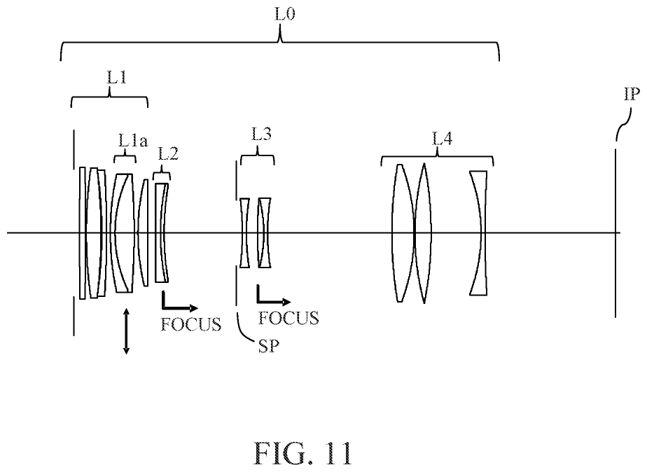

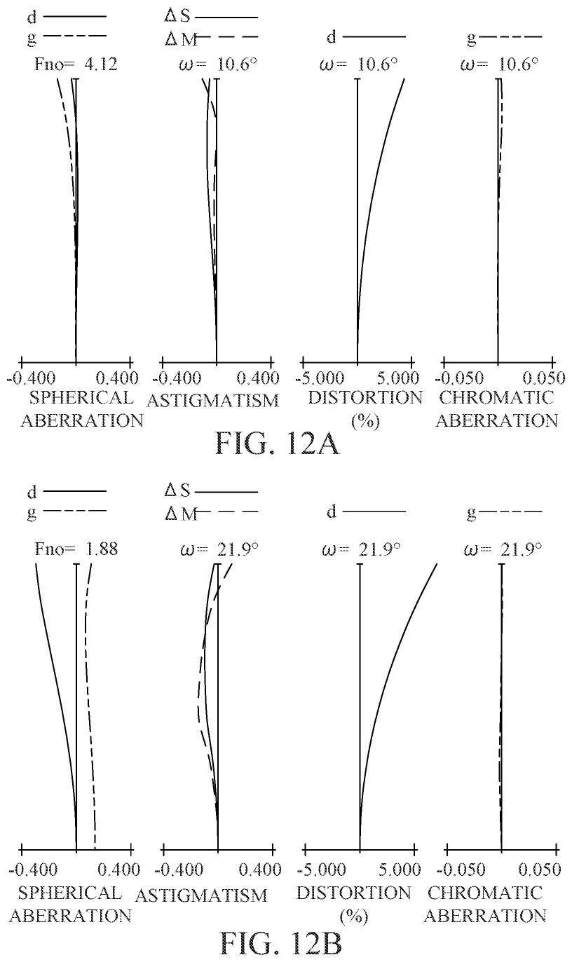

FIG. 11 is a lens sectional view of an optical system L0 according to Example 6 in the in-focus state at infinity. FIG. 12A is a longitudinal aberration diagram of the optical system L0 according to Example 6 in the in-focus state at infinity. FIG. 12B is a longitudinal aberration diagram of the optical system L0 according to Example 6 at an imaging magnification of −1.0. The optical system L0 according to Example 6 is an optical system having an F-number of about four.

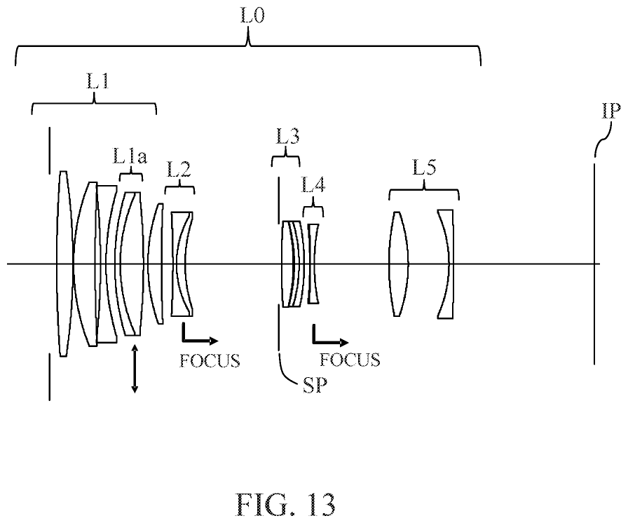

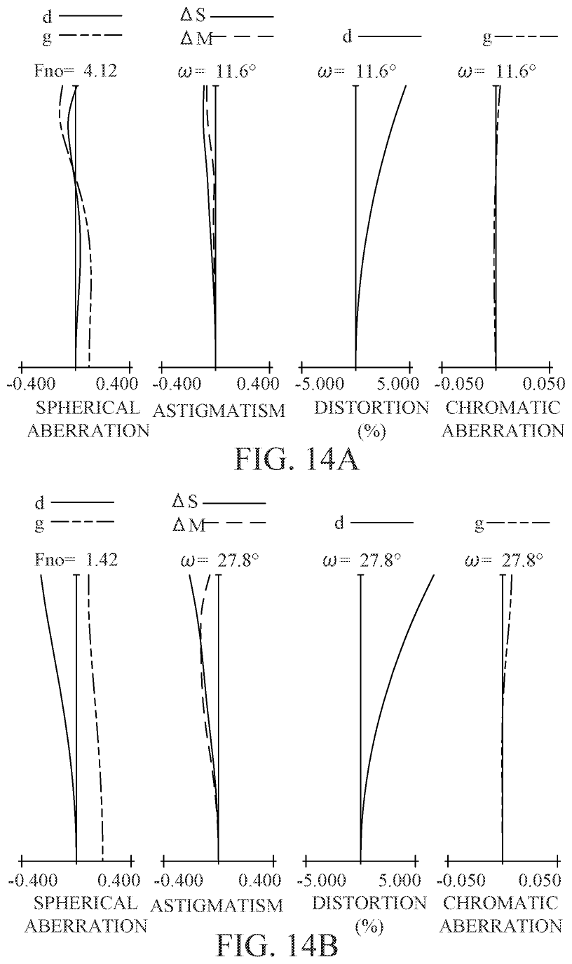

FIG. 13 is a lens sectional view of an optical system L0 according to Example 7 in the in-focus state at infinity. FIG. 14A is a longitudinal aberration diagram of the optical system L0 according to Example 7 in the in-focus state at infinity. FIG. 14B is a longitudinal aberration diagram of the optical system L0 according to Example 7 at an imaging magnification of −1.0. The optical system L0 according to Example 7 is an optical system having an F-number of about four.

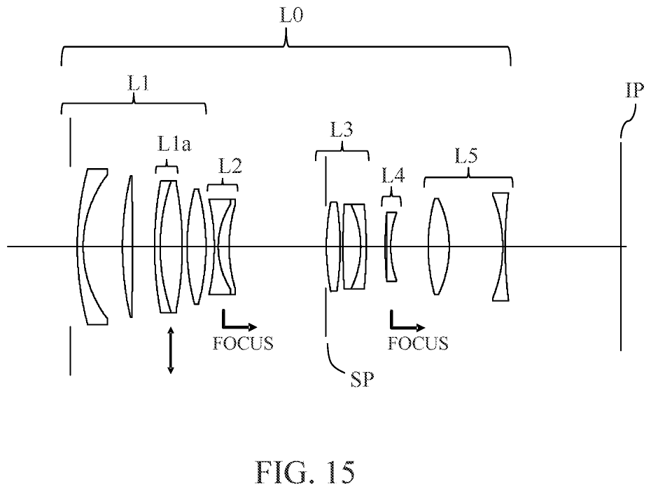

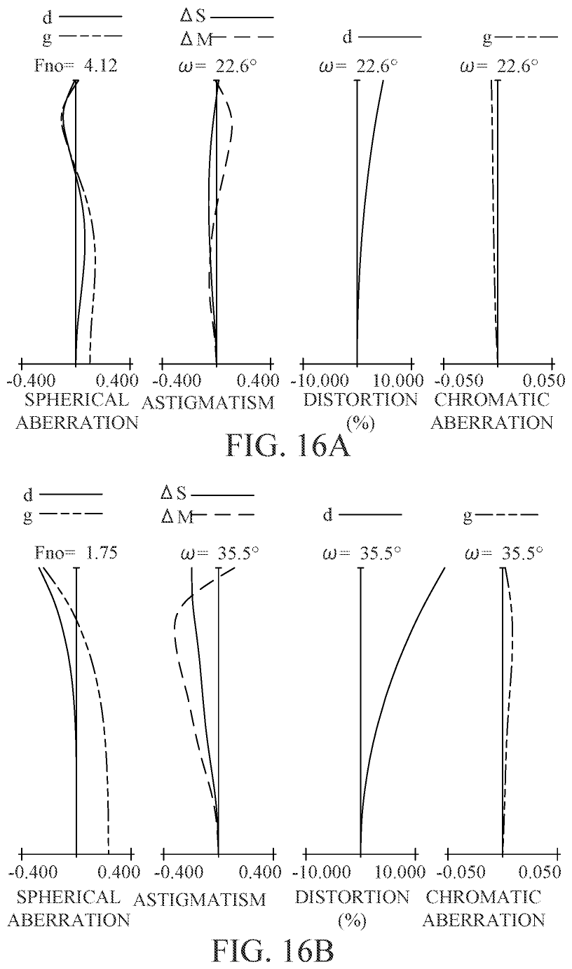

FIG. 15 is a lens sectional view of an optical system L0 according to Example 8 in the in-focus state at infinity. FIG. 16A is a longitudinal aberration diagram of the optical system L0 according to Example 8 in the in-focus state at infinity. FIG. 16B is a longitudinal aberration diagram of the optical system L0 according to Example 8 at an imaging magnification of −1.0. The optical system L0 according to Example 8 is an optical system having an F-number of about four.

In each lens sectional view, a left side is an object side, and a right side is an image side. The optical system L0 according to each example includes a plurality of lens units. In this specification, a lens unit is a group of lenses that move together or stand still during focusing. That is, in the optical system L0 according to each example, a distance between adjacent lens units changes during focusing from infinity to a close distance (a short distance). The lens unit may include one or more lenses. The lens unit may include an aperture stop.

Li represents an i-th lens unit where i is order of the lens units counted from the object side (i is a natural number). The optical system L0 according to each example includes a plurality of lens units Li.

SP represents an aperture stop (diaphragm). IP is an image plane. In a case where the optical system L0 according to each example is used as an imaging optical system for a digital still camera or a digital video camera, an imaging plane of a solid-state image sensor (photoelectric conversion element) such as a CCD sensor or a CMOS sensor is placed on the image plane IP. In a case where the optical system L0 according to each example is used as an imaging optical system for a film-based camera, a photosensitive plane corresponding to the film plane is placed on the image plane IP.

An arrow relating to “focus” illustrated in each lens sectional view indicates a moving direction of the lens unit during focusing from infinity to a close distance.

FIGS. 2A, 2B, 4A, 4B, 6A, 6B, 8A, 8B, 10A, 10B, 12A, 12B, 14A, 14B, 16A, and 16B are aberration diagrams of the optical systems L0 according to Examples 1 to 8, respectively. In each aberration diagram, FIGS. 2A, 4A, 6A, 8A, 10A, 12A, 14A, and 16A are aberration diagrams of the optical systems L0 in the in-focus states at infinity. FIGS. 2B, 4B, 6B, 8B, 10B, 12B, 14B, and 16B are aberration diagrams of the optical systems L0 at imaging magnifications of −1.0 or −0.5.

In a spherical aberration diagram, Fno represents an F-number. The spherical aberration diagram indicates spherical aberration amounts for the d-line (wavelength 587.6 nm) and g-line (wavelength 435.8 nm). In an astigmatism diagram, dS indicates an astigmatism amount on a sagittal image plane, and dM indicates an astigmatism amount on a meridional image plane. A distortion diagram illustrates a distortion amount for the d-line. The distortion is expressed by a value for the d-line based on the equisolid angle projection method at the shortest and intermediate focal lengths, and a value for the d-line at the longest focal length based on the central projection method. A chromatic aberration diagram illustrates a chromatic aberration amount for the g-line. ω is a paraxial imaging half angle of view (°).

A description will now be given of a characteristic configuration of the optical system L0 according to each example.

The optical system L0 according to each example includes, in order from the object side, to the image side a first lens unit L1, a second lens unit L2, a third lens unit L3, and a fourth lens unit L4. A distance between adjacent lens units changes during focusing from infinity to a close. An aperture stop SP is disposed on the image side of the second lens unit L2. The first lens unit L1 and the final lens unit located closest to the image plane in the optical system L0 are fixed relative to the image plane IP during focusing from infinity to a close distance. Focus lens units are disposed on the object side and the image side of the aperture stop SP and configured to move during focusing from infinity to a close distance. A focus lens unit closest to the image plane among the focus lens units moves toward the image side during focusing from infinity to a close distance. The optical system L0 is configured to increase an absolute value of an imaging magnification at the shortest imaging distance to 0.5 times or higher. The final lens unit includes a positive lens and a negative lens.

The optical system L0 according to each example satisfies the following inequality (1):

0.025<dF/L<0.099 (1)

where dF is a sum of distances on the optical axis from a lens surface closest to the object to a lens surface closest to the image plane in each focus lens unit, and L is an overall lens length of the optical system L0.

Inequality (1) defines a ratio of an overall thickness dF1 of all the focus lens units to the overall lens length L of the optical system L0. In a case where the value dF/L is lower than the lower limit of inequality (1), the overall lens length L becomes too large. In a case where the overall thickness dF increases and the value dF/L is higher than the upper limit of inequality (1), the size of the focus lens unit increases, focusing speed decreases, and the size of the optical system L0 increases.

Inequality (1) may be replaced with inequality (1a) below:

0.026<dF/L<0.098 (1a)

Inequality (1) may be replaced with inequality (1b) below:

0.027<dF/L<0.097 (1b)

A description will now be given of a configuration that may be satisfied by the optical system L0 according to each example.

Each focus lens unit may consist of four lenses or less. This configuration can reduce the weight of each focus lens unit and provide quick focusing.

The final lens unit may consist of, in order from the object side to the image side, a positive subunit and a negative subunit. Thereby, the final lens unit has a telephoto arrangement, and the overall lens length of the optical system L0 can be restrained from increasing.

The first lens unit L1 may have positive refractive power. Thereby, the entire optical system L0 becomes closer to the telephoto arrangement, and the overall lens length of the optical system L0 can be restrained from increasing.

One focus lens unit may be disposed on each of the object side and the image side of the aperture stop SP. That is, the number of focus lens units disposed on the object side of the aperture stop SP may be one, and the number of focus lens units disposed on the image side of the aperture stop SP may be one. This configuration can simplify the focus driving unit, and restrain the optical system L0 from becoming large.

Among the focus lens units disposed on the image side of the aperture stop SP, the focus lens unit disposed closest to the object may have negative refractive power. Thereby, the focus lens unit can be restrained from becoming large. In addition, disposing a lens unit having negative refractive power near the aperture stop SP enables the curvature of field to be easily corrected.

The first lens unit L1 may include a subunit L1a configured to move in a direction including a component orthogonal to the optical axis during image stabilization. This configuration can suppress the influence of camera shake during imaging and provides high-resolution imaging.

A description will be given of conditions that the optical system L0 according to each example may satisfy. The optical system L0 according to each example may satisfy one or more of the following inequalities (2) to (9):

0.0<|f1/fL|<1.0 (2)

0.1<|(1−βf²)×βr²|<5.1 (3)

0.8<L/f<2.4 (4)

0.2<f1/f<1.3 (5)

0.1<|f2/f|<2.5 (6)

0.2<|f3/f|<0.8 (7)

0.1<|f4/f|<0.9 (8)

|β|≥0.5 (9)

Here, f1 is a focal length of the first lens unit L1. fL is a focal length of the final lens unit. βf is a lateral magnification of the focus lens unit closest to the image plane among the focus lens units. βr is a combined lateral magnification of all the lens units disposed on the image side of the focus lens unit closest to the image plane among the focus lens units. f is a focal length of the optical system L0. f2 is a focal length of the second lens unit. f3 is a focal length of the third lens unit. f4 is a focal length of the fourth lens unit. β is an imaging magnification at the shortest imaging distance of the optical system L0.

Inequality (2) defines a ratio of the focal length f1 of the first lens unit L1 to the focal length fL of the final lens unit. In a case where the focal length f1 of the first lens unit L1 becomes small and the value |f1/fL| becomes lower than the lower limit of inequality (2), the refractive power of the first lens unit becomes too strong, and a light ray converged or diverged by the first lens unit cause spherical aberration and coma significantly. It becomes thus difficult to correct aberrations in the subsequent lens units. In a case where the focal length f1 of the first lens unit increases and the value |f1/fL| becomes higher than the upper limit of inequality (2), which is beneficial to aberration correction, the overall lens length becomes long because the lens unit has no refractive power, and size and weight reductions are hindered.

Inequality (3) defines the focus sensitivity of the focus lens unit closest to the image plane among the focus lens units. In a case where the value |(1−βf²)×βr²| becomes lower than the lower limit of inequality (3), a moving amount of the focus lens unit closest to the image plane among the focus lens units increases, and the overall lens length of the optical system L0 increases. In a case where the value |(1−βf²)×βr²| becomes higher than the upper limit of inequality (3), the focusing stop accuracy of the focus lens unit closest to the image plane during focusing becomes low, and it becomes difficult to achieve proper focusing.

Inequality (4) defines a ratio of the overall lens length L of the optical system L0 to the focal length f of the optical system L0. In a case where the focal length f increases and the value L/f becomes lower than the lower limit of inequality (4), the overall lens length L of the optical system L0 undesirably increases. In a case where the focal length f becomes small and the value L/f becomes higher than the upper limit of inequality (4), it becomes difficult to correct various aberrations.

Inequality (5) defines a ratio of the focal length f1 of the first lens unit L1 to the focal length f of the optical system L0. In a case where the focal length f1 becomes so short that the value f1/f becomes lower than the lower limit of inequality (5), correction of various aberrations becomes difficult. In a case where the focal length f1 becomes so long that the value f1/f becomes higher than the upper limit of inequality (5), the overall lens length of the optical system L0 undesirably increases.

Inequality (6) defines a ratio of the focal length f2 of the second lens unit L2 to the focal length f of the optical system L0. Inequality (6) is to reduce the occurrence of spherical aberration, and in a case where the value |f2/f| is maintained within the range of inequality (6), correction of spherical aberration becomes easier.

Inequality (7) defines a ratio of the focal length f3 of the third lens unit L3 to the focal length f of the optical system L0. Inequality (7) is to reduce the occurrence of spherical aberration, and in a case where the value |f3/f| is maintained within the range of inequality (7), correction of spherical aberration becomes easier.

Inequality (8) defines a ratio of the focal length f4 of the fourth lens unit L4 to the focal length f of the optical system L0. Inequality (8) is to reduce the occurrence of curvature of field, and in a case where the value |f4/f| is maintained within the range of inequality (8), correction of field curvature becomes easier.

Inequality (9) defines the condition of the imaging magnification β at the shortest imaging distance of the optical system L0. In a case where the value |β| becomes lower than the lower limit of inequality (9), high-magnification imaging becomes difficult.

Inequalities (2) to (9) may be replaced with inequalities (2a) to (9a) below:

0.0<|f1/fL|<0.95 (2a)

0.2<|(1−βf²)×βr²|<5.0 (3a)

1.0<L/f<2.3 (4a)

0.3<f1/f<1.2 (5a)

0.2<|f2/f|<2.4 (6a)

0.3<|f3/f|<0.7 (7a)

0.2<|f4/f|<0.8 (8a)

|β|≥0.7 (9a)

Inequalities (2) to (9) may be replaced with inequalities (2b) to (9b) below:

0.0<|f1/fL|<0.9 (2b)

0.3<|(1−βf²)×βr²|<4.9 (3b)

1.05<L/f<2.22 (4b)

0.4<f1/f<1.1 (5b)

0.3<|f2/f|<2.3 (6b)

0.33<|f3/f|<0.65 (7b)

0.3<|f4/f|<0.7 (8b)

|β|≥1.0 (9b)

A detailed description will now be given of the optical system L0 according to each example.

The optical system L0 according to Example 1 consists of, in order from the object side to the image side, a first lens unit L1 having positive refractive power, a second lens unit L2 having negative refractive power, a third lens unit L3 having positive refractive power, a fourth lens unit L4 having negative refractive power, and a fifth lens unit L5 having positive refractive power.

In the optical system L0 according to Example 1, the first lens unit L1, the third lens unit L3, and the fifth lens unit L5 are fixed relative to the image plane IP during focusing from infinity to a close distance. During focusing from infinity to a close distance, the second lens unit L2 and the fourth lens unit L4 move toward the image side. The third lens unit L3 includes an aperture stop SP, and the aperture stop SP is disposed closest to the object in the third lens unit L3.

The optical system L0 according to Example 2 consists of, in order from the object side to the image side, a first lens unit L1 having positive refractive power, a second lens unit L2 having positive refractive power, a third lens unit L3 having positive refractive power, a fourth lens unit L4 having negative refractive power, and a fifth lens unit L5 having positive refractive power.

In the optical system L0 according to Example 2, the first lens unit L1, the third lens unit L3, and the fifth lens unit L5 are fixed relative to the image plane IP during focusing from infinity to a close distance. During focusing from infinity to a close distance, the second lens unit L2 moves toward the object side, and the fourth lens unit L4 moves toward the image side. The third lens unit L3 includes an aperture stop SP, and the aperture stop SP is disposed closest to the object in the third lens unit L3.

The optical system L0 according to Example 3 consists of, in order from the object side to the image side, a first lens unit L1 having positive refractive power, a second lens unit L2 having negative refractive power, a third lens unit L3 having positive refractive power, a fourth lens unit L4 having negative refractive power, and a fifth lens unit L5 having positive refractive power.

The first lens unit L1, the third lens unit L3, and the fifth lens unit L5 are fixed relative to the image plane IP during focusing from infinity to a close distance. During focusing from infinity to a close distance, the second lens unit L2 and the fourth lens unit L4 move toward the image side. The third lens unit L3 includes an aperture stop SP, and the aperture stop SP is disposed closest to the object in the third lens unit L3.

The optical system L0 according to Example 4 consists of, in order from the object side to the image side, a first lens unit L1 having positive refractive power, a second lens unit L2 having negative refractive power, a third lens unit L3 having positive refractive power, a fourth lens unit L4 having negative refractive power, a fifth lens unit L5 having positive refractive power, and a sixth lens unit L6 having positive refractive power.

The first lens unit L1, the third lens unit L3, and the sixth lens unit L6 are fixed relative to the image plane IP during focusing from infinity to a close distance. The second lens unit L2, the fourth lens unit L4, and the fifth lens unit L5 move toward the image side during focusing from infinity to a close distance. The third lens unit L3 includes an aperture stop SP, and the aperture stop SP is disposed closest to the object in the third lens unit L3.

The optical system L0 according to Example 5 consists of, in order from the object side to the image side, a first lens unit L1 having positive refractive power, a second lens unit L2 having negative refractive power, a third lens unit L3 having positive refractive power, a fourth lens unit L4 having negative refractive power, and a fifth lens unit L5 having negative refractive power.

The first lens unit L1, the third lens unit L3, and the fifth lens unit L5 are fixed relative to the image plane IP during focusing from infinity to a close distance. During focusing from infinity to a close distance, the second lens unit L2 and the fourth lens unit L4 move toward the image side. The third lens unit L3 includes an aperture stop SP, and the aperture stop SP is disposed closest to the object in the third lens unit L3.

The optical system L0 according to Example 6 consists of, in order from the object side to the image side, a first lens unit L1 having positive refractive power, a second lens unit L2 having negative refractive power, an aperture stop SP, a third lens unit L3 having negative refractive power, and a fourth lens unit L4 having positive refractive power.

The first lens unit L1, the aperture stop SP, and the fourth lens unit L4 are fixed relative to the image plane IP during focusing from infinity to a close distance. During focusing from infinity to a close distance, the second lens unit L2 and the third lens unit L3 move toward the image side.

The optical system L0 according to Example 7 consists of, in order from the object side to the image side, a first lens unit L1 having positive refractive power, a second lens unit L2 having negative refractive power, a third lens unit L3 having positive refractive power, a fourth lens unit L4 having negative refractive power, and a fifth lens unit L5 having negative refractive power.

During focusing from infinity to a close distance, the first lens unit L1, the third lens unit L3, and the fifth lens unit L5 are fixed relative to the image plane IP. During focusing from infinity to a close distance, the second lens unit L2 and the fourth lens unit L4 move toward the image side. The third lens unit L3 includes an aperture stop SP, and the aperture stop SP is disposed closest to the object in the third lens unit L3.

The optical system L0 according to Example 8 consists of, in order from the object side to the image side, a first lens unit L1 having positive refractive power, a second lens unit L2 having negative refractive power, a third lens unit L3 having positive refractive power, a fourth lens unit L4 having negative refractive power, and a fifth lens unit L5 having positive refractive power.

The first lens unit L1, the third lens unit L3, and the fifth lens unit L5 are fixed relative to the image plane IP during focusing from infinity to a close distance. During focusing from infinity to a close distance, the second lens unit L2 and the fourth lens unit L4 move toward the image side. The third lens unit L3 includes an aperture stop SP, and the aperture stop SP is disposed closest to the object in the third lens unit L3.

As described above, in the macro lens, each example can reduce the weight and size of the focus lens unit, improve the focusing stop accuracy, increase the focusing speed, and provide a compact and high-performance optical system.

Numerical examples 1 to 8 corresponding to examples 1 to 8 will be illustrated below.

In surface data in each numerical example, r represents a radius of curvature of each optical surface, and d (mm) represents an on-axis distance (distance on the optical axis) between an m-th surface and an (m+1)-th surface, where m is a surface number counted from the light incident side. nd represents a refractive index for the d-line of each optical element, and vd represents an Abbe number of the optical element. The Abbe number vd of a certain material is expressed as follows:

vd=(Nd−1)/(NF−NC)

where Nd, NF, and NC are refractive indices based on the d-line (587.6 nm), the F-line (486.1 nm), and the C-line (656.3 nm) in the Fraunhofer line, respectively. An effective diameter means a diameter of an area (effective area) of the lens surface through which an effective light beam that contributes to imaging passes.

In each numerical example, values of d, focal length (mm), F-number, and half angle of view (°) are set in a case where the optical system according to each example is in an in-focus state on an infinity object. “Back focus BF” is a distance on the optical axis from the final lens surface (lens surface closest to the image plane) to the paraxial image plane expressed in air conversion length. An “overall lens length” is a length obtained by adding the back focus to a distance on the optical axis from the first lens surface (lens surface closest to the object) of the optical system L0 to the final lens surface. The term “lens unit” includes one or more lenses.

In a case where the optical surface is an aspherical surface, an asterisk * is attached to the right side of the surface number. The aspherical shape is expressed as follows:

X=(h²/R)/[1+{1−(1+k)(h/R)²}^{1/2}]+A4×h⁴+A6×h⁶+A8×h⁸+A10×h¹⁰+A12×h¹²

where X is a displacement amount from a surface vertex in the optical axis direction, h is a height from the optical axis in a direction orthogonal to the optical axis, a light traveling direction is set positive, R is a paraxial radius of curvature, k is a conic constant, and A4, A6, A8, A10, and A12 are aspherical coefficients. “e±XX” in each aspheric coefficient means “×10^{±XX}.”

### Numerical Example 1

UNIT: mm
SURFACE DATA

| Surface | | | | | Effective |
|---|---|---|---|---|---|
| No | r | d | nd | νd | Diameter |
| 1 | ∞ | 1.50 | | | 37.21 |
| 2 | 185.879 | 3.29 | 1.95375 | 32.3 | 36.32 |
| 3 | −182.103 | 0.13 | | | 35.88 |
| 4 | 58.616 | 5.18 | 1.49700 | 81.5 | 33.11 |
| 5 | −191.217 | 0.25 | | | 31.53 |
| 6 | −139.020 | 1.20 | 1.85478 | 24.8 | 31.51 |
| 7 | 64.476 | 1.84 | | | 29.58 |
| 8 | 60.127 | 1.20 | 1.80328 | 30.0 | 28.59 |
| 9 | 40.819 | 4.45 | 1.49700 | 81.5 | 27.62 |
| 10 | −169.716 | 0.97 | | | 26.91 |
| 11 | 37.977 | 2.47 | 1.49700 | 81.5 | 24.00 |
| 12 | 117.183 | (Variable) | | | 23.14 |
| 13 | −224.411 | 0.80 | 1.77959 | 49.2 | 20.96 |
| 14 | 21.839 | 2.19 | 1.92286 | 20.9 | 20.12 |
| 15 | 36.163 | (Variable) | | | 19.78 |
| 16 | ∞ | 0.63 | | | 18.72 |
| (Aperture | | | | | |
| Stop) | | | | | |
| 17 | 158.702 | 2.48 | 1.95375 | 32.3 | 18.67 |
| 18 | −47.239 | 0.12 | | | 18.56 |
| 19 | −36.943 | 1.37 | 1.55787 | 64.9 | 18.65 |
| 20 | −29.099 | 1.10 | 1.84666 | 23.8 | 18.47 |
| 21 | −41.530 | (Variable) | | | 18.42 |
| 22* | −101.372 | 0.05 | 1.53110 | 55.9 | 17.54 |
| 23 | −103.203 | 0.90 | 1.53887 | 64.2 | 17.53 |
| 24 | 41.709 | (Variable) | | | 17.02 |
| 25 | 57.353 | 4.33 | 1.48749 | 70.2 | 21.50 |
| 26 | −35.413 | 11.10 | | | 21.83 |
| 27 | −27.840 | 1.00 | 1.69387 | 29.6 | 21.78 |
| 28 | 1604.966 | 34.03 | | | 22.88 |
| Image | ∞ | | | | |
| Surface | | | | | |

ASPHERIC DATA
22nd Surface
K = 0.00000e+00 A4 = −8.05214e−07 A6 = 2.03352e−08
A8 = −2.81786e−10 A10 = 1.26453e−12
VARIOUS DATA

| | |
|---|---|
| Focal Length | 111.29 |
| Fno | 4.12 |
| Half Angle of View (°) | 11.00 |
| Image Height | 21.64 |
| Overall Lens Length | 125.00 |
| BF | 34.03 |

| | | |
|---|---|---|
| Imaging Magnification | Infinity | −1.0 |
| d12 | 2.82 | 19.92 |
| d15 | 20.41 | 3.36 |
| d21 | 1.23 | 17.23 |
| d24 | 17.92 | 1.89 |
| Entrance | 67.03 | 104.82 |
| Pupil Position | | |
| Exit Pupil | −25.35 | −21.72 |
| Position | | |
| Front Principal | −30.27 | −47.81 |
| Point Position | | |
| Rear Principal | −77.26 | −56.69 |
| Point Position | | |

Lens Unit Data

| | | | | Front | Rear |
|---|---|---|---|---|---|
| | | | Lens | Principal | Principal |
| Lens | Starting | Focal | Structure | Point | Point |
| Unit | Surface | Length | Length | Position | Position |
| 1 | 1 | 52.51 | 22.50 | 7.15 | −9.51 |
| 2 | 13 | −44.70 | 2.99 | 1.68 | 0.09 |
| 3 | 16 | 46.87 | 5.70 | 2.54 | −1.00 |
| 4 | 22 | −54.72 | 0.95 | 0.44 | −0.18 |
| 5 | 25 | 296.90 | 16.43 | −90.32 | −80.24 |

SINGLE LENS DATA

| | Starting | |
|---|---|---|
| Lens | Surface | Focal Length |
| 1 | 1 | 96.87 |
| 2 | 4 | 90.90 |
| 3 | 6 | −51.39 |
| 4 | 8 | −162.75 |
| 5 | 9 | 66.67 |
| 6 | 11 | 111.89 |
| 7 | 13 | −25.49 |
| 8 | 14 | 55.66 |
| 9 | 17 | 38.39 |
| 10 | 19 | 231.21 |
| 11 | 20 | −119.67 |
| 12 | 22 | −10862.67 |
| 13 | 23 | −55.00 |
| 14 | 25 | 45.61 |
| 15 | 27 | −39.43 |

### Numerical Example 2

UNIT: mm
SURFACE DATA

| Surface | | | | | Effective |
|---|---|---|---|---|---|
| No | r | d | nd | νd | Diameter |
| 1 | ∞ | 1.50 | | | 27.70 |
| 2 | 38.294 | 3.54 | 2.00100 | 29.1 | 25.98 |
| 3 | 343.053 | 2.60 | | | 25.10 |
| 4 | 499.265 | 1.00 | 1.58913 | 61.1 | 22.03 |
| 5 | 31.000 | 3.60 | | | 20.19 |
| 6 | −10384.825 | 1.00 | 1.85478 | 24.8 | 18.78 |
| 7 | 32.326 | 2.39 | | | 18.43 |
| 8 | 51.874 | 1.00 | 1.67300 | 38.1 | 19.09 |
| 9 | 31.293 | 3.49 | 1.49700 | 81.5 | 9.18 |
| 10 | −69.451 | 0.97 | | | 19.35 |
| 11 | 37.877 | 2.38 | 1.49700 | 81.5 | 19.54 |
| 12 | −741.291 | | | | 19.40 |
| | (Variable) | | | | |
| 13 | −170.842 | 0.75 | 1.56932 | 39.1 | 19.00 |
| 14 | 35.293 | 2.65 | 1.74983 | 45.3 | 18.78 |
| 15 | −239.271 | | | | 18.61 |
| | (Variable) | | | | |
| 16 | ∞ | 3.28 | | | 16.71 |
| (Aperture | | | | | |
| Stop) | | | | | |
| 17 | −16.832 | 1.40 | 1.95375 | 32.3 | 16.35 |
| 18 | −17.300 | 0.15 | | | 16.86 |
| 19 | 218.205 | 4.09 | 1.69680 | 55.5 | 16.09 |
| 20 | −16.372 | 0.70 | 1.88300 | 40.8 | 15.67 |
| 21 | −36.649 | | | | 15.53 |
| | (Variable) | | | | |
| 22 | −52.745 | 1.55 | 1.72172 | 43.0 | 14.53 |
| 23 | −20.223 | 0.90 | 1.53775 | 74.7 | 14.39 |
| 24 | 21.238 | | | | 13.33 |
| | (Variable) | | | | |
| 25 | 173.567 | 7.05 | 1.57703 | 63.8 | 33.38 |
| 26 | −33.331 | 9.01 | | | 33.91 |
| 27 | −31.255 | 1.40 | 1.72916 | 54.7 | 32.62 |
| 28 | −75.010 | 21.58 | | | 34.30 |
| Image | ∞ | | | | |
| Surface | | | | | |

VARIOUS DATA

| | |
|---|---|
| Focal Length | 90.00 |
| Fno | 4.12 |
| Half Angle of View (°) | 13.52 |
| Image Height | 21.64 |
| Overall Lens Length | 120.00 |
| BF | 21.58 |

| | | |
|---|---|---|
| Imaging Magnification | Infinity | −1.0 |
| d12 | 9.07 | 2.17 |
| d15 | 0.87 | 7.79 |
| d21 | 1.44 | 23.18 |
| d24 | 30.72 | 8.97 |

| | | | | | |
|---|---|---|---|---|---|
| Entrance | 40.56 | 41.07 | 41.15 | 39.90 | 40.55 |
| Pupil | | | | | |
| Position | | | | | |
| Exit Pupil | −63.04 | −63.72 | −40.86 | −59.28 | −53.34 |
| Position | | | | | |
| Front | 34.85 | 33.79 | 1.93 | 23.63 | 15.50 |
| Principal | | | | | |
| Point | | | | | |
| Position | | | | | |
| Rear | −68.41 | −70.45 | −60.97 | −72.67 | −71.17 |
| Principal | | | | | |
| Point | | | | | |
| Position | | | | | |

Lens Unit Data

| | | | | Front | Rear |
|---|---|---|---|---|---|
| | | | | Prin- | Prin- |
| | | | Lens | cipal | cipal |
| Lens | Starting | Focal | Structure | Point | Point |
| Unit | Surface | Length | Length | Position | Position |
| 1 | 1 | 93.73 | 23.47 | 11.00 | −10.53 |
| 2 | 13 | 203.23 | 3.40 | 1.76 | −0.23 |
| 3 | 16 | 58.10 | 9.61 | 8.59 | 1.96 |
| 4 | 22 | −33.14 | 2.45 | 0.97 | −0.49 |
| 5 | 25 | 105.72 | 17.46 | −9.19 | −21.13 |

SINGLE LENS DATA

| | Starting | Focal |
|---|---|---|
| Lens | Surface | Length |
| 1 | 1 | 42.81 |
| 2 | 4 | −56.15 |
| 3 | 6 | −37.70 |
| 4 | 8 | −119.53 |
| 5 | 9 | 43.91 |
| 6 | 11 | 72.58 |
| 7 | 13 | −51.31 |
| 8 | 14 | 41.19 |
| 9 | 17 | 1415.98 |
| 10 | 19 | 22.01 |
| 11 | 20 | −34.06 |
| 12 | 22 | 44.55 |
| 13 | 23 | −19.12 |
| 14 | 25 | 49.07 |
| 15 | 27 | −74.49 |

### Numerical Example 3

UNIT: mm
SURFACE DATA

| Surface No | r | d | nd | νd | Effective Diameter |
|---|---|---|---|---|---|
| 1 | ∞ | 1.50 | | | 29.20 |
| 2 | 137.714 | 2.88 | 1.95375 | 32.3 | 28.34 |
| 3 | −156.964 | 0.15 | | | 27.88 |
| 4 | 39.757 | 4.70 | 1.49700 | 81.5 | 25.54 |
| 5 | −185.324 | 0.17 | | | 24.54 |
| 6 | −133.370 | 1.20 | 1.85478 | 24.8 | 24.52 |
| 7 | 54.137 | 1.25 | | | 23.56 |
| 8 | 36.053 | 1.20 | 1.54455 | 62.5 | 23.19 |
| 9 | 24.683 | 2.12 | 1.49700 | 81.5 | 22.46 |
| 10 | 37.720 | 0.97 | | | 22.08 |
| 11 | 38.076 | 2.45 | 1.49700 | 81.5 | 21.88 |
| 12 | 174.487 | (Variable) | | | 21.48 |
| 13 | 743.088 | 1.20 | 1.69178 | 41.2 | 20.57 |
| 14 | 19.940 | 1.96 | 1.92286 | 20.9 | 19.55 |
| 15 | 28.454 | (Variable) | | | 19.15 |
| 16 (Aperture Stop) | ∞ | 4.37 | | | 18.48 |
| 17 | −605.953 | 1.40 | 1.95375 | 32.3 | 18.19 |
| 18 | −109.007 | 0.15 | | | 18.21 |
| 19 | −1455.101 | 0.50 | 1.54833 | 43.7 | 18.18 |
| 20 | 55.907 | 1.77 | 1.72915 | 54.7 | 18.14 |
| 21 | −77.622 | (Variable) | | | 18.11 |
| 22* | −117.521 | 0.21 | 1.53110 | 55.9 | 17.17 |
| 23 | −77.304 | 1.50 | 1.48785 | 70.2 | 17.16 |
| 24 | 44.651 | 2.37 | | | 16.50 |
| 25 | −346.126 | 2.10 | 1.88300 | 40.8 | 16.24 |
| 26 | −47.567 | 1.19 | | | 16.13 |
| 27 | −41.412 | 1.00 | 1.50547 | 66.6 | 15.62 |
| 28 | 171.592 | (Variable) | | | 16.05 |
| 29 | 308.375 | 3.69 | 1.48749 | 70.2 | 24.10 |
| 30 | −39.533 | 2.40 | | | 24.55 |
| 31 | −49.252 | 1.00 | 1.84666 | 23.8 | 24.89 |
| 32 | −136.037 | 43.07 | | | 25.51 |
| Image Surface | ∞ | | | | |

ASPHERIC DATA

22nd Surface
K = 0.00000e+00 A4 = −4.22246e−07 A6 = 3.64925e−09 A8 = −4.07067e−11
A10 = 2.40919e−13

VARIOUS DATA

| | |
|---|---|
| Focal Length | 110.00 |
| Fno | 4.12 |
| Half Angle of View (°) | 11.13 |
| Image Height | 21.64 |
| Overall Lens Length | 119.99 |
| BF | 43.07 |

| Imaging Magnification | Infinity | −0.5 |
|---|---|---|
| d12 | 2.25 | 10.07 |
| d15 | 11.47 | 3.66 |
| d21 | 1.32 | 16.53 |
| d28 | 16.45 | 1.24 |

| | | | | |
|---|---|---|---|---|
| Entrance Pupil Position | 46.44 | 46.75 | 52.14 | 49.73 |
| Exit Pupil Position | −37.53 | −37.38 | −31.21 | −35.11 |
| Front Principal Point Position | 6.31 | 5.10 | −21.21 | −8.15 |
| Rear Principal Point Position | −66.93 | −67.47 | −68.07 | −70.46 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 58.71 | 18.59 | 1.06 | −11.99 |
| 2 | 13 | −51.32 | 3.16 | 2.45 | 0.69 |
| 3 | 16 | 51.78 | 8.20 | 5.95 | −0.64 |
| 4 | 22 | −71.65 | 8.37 | 1.74 | −4.61 |
| 5 | 29 | 301.70 | 7.10 | −5.62 | −10.80 |

SINGLE LENS DATA

| Lens | Starting Surface | Focal Length |
|---|---|---|
| 1 | 1 | 77.28 |
| 2 | 4 | 66.32 |
| 3 | 6 | −44.92 |
| 4 | 8 | −149.29 |
| 5 | 9 | 136.34 |
| 6 | 11 | 97.42 |
| 7 | 13 | −29.64 |
| 8 | 14 | 65.01 |
| 9 | 17 | 139.17 |
| 10 | 19 | −98.17 |
| 11 | 20 | 44.82 |
| 12 | 22 | 424.56 |
| 13 | 23 | −57.78 |
| 14 | 25 | 62.25 |
| 15 | 27 | −65.90 |
| 16 | 29 | 72.13 |
| 17 | 31 | −91.67 |

### Numerical Example 4

UNIT: mm
SURFACE DATA

| Surface No | r | d | nd | νd | Effective Diameter |
|---|---|---|---|---|---|
| 1 | ∞ | 1.50 | | | 30.10 |
| 2 | 128.915 | 3.02 | 1.95375 | 32.3 | 29.21 |
| 3 | −161.611 | 0.15 | | | 28.73 |
| 4 | 40.041 | 4.88 | 1.49700 | 81.5 | 26.22 |
| 5 | −171.138 | 0.15 | | | 24.46 |
| 6 | −129.965 | 1.20 | 1.85478 | 24.8 | 24.46 |
| 7 | 52.971 | 1.15 | | | 23.47 |
| 8 | 33.976 | 1.20 | 1.52995 | 63.3 | 23.09 |
| 9 | 22.209 | 2.38 | 1.49700 | 81.5 | 22.27 |
| 10 | 34.922 | 0.97 | | | 21.86 |
| 11 | 37.389 | 2.53 | 1.49700 | 81.5 | 21.68 |
| 12 | 210.122 | (Variable) | | | 21.26 |
| 13 | 2698.680 | 1.20 | 1.69849 | 42.7 | 20.32 |
| 14 | 19.441 | 1.98 | 1.92286 | 20.9 | 19.29 |
| 15 | 27.846 | (Variable) | | | 18.89 |
| 16 (Aperture Stop) | ∞ | 4.88 | | | 18.28 |
| 17 | −330.153 | 1.37 | 1.95375 | 32.3 | 17.99 |
| 18 | −100.710 | 0.15 | | | 17.99 |
| 19 | 2911.242 | 0.50 | 1.54812 | 43.8 | 17.97 |
| 20 | 51.866 | 1.83 | 1.72917 | 54.7 | 17.94 |
| 21 | −74.366 | (Variable) | | | 17.92 |
| 22* | −112.030 | 0.05 | 1.53110 | 55.9 | 17.00 |
| 23 | −114.811 | 1.50 | 1.49230 | 69.6 | 16.99 |
| 24 | 42.149 | (Variable) | | | 16.37 |
| 25 | −262.895 | 2.00 | 1.83707 | 43.7 | 16.13 |
| 26 | −47.464 | 1.12 | | | 16.04 |
| 27 | −37.120 | 1.00 | 1.50424 | 68.1 | 15.74 |
| 28 | −224.938 | (Variable) | | | 16.30 |
| 29 | 531.967 | 3.55 | 1.48749 | 70.2 | 24.38 |
| 30 | −45.239 | 3.71 | | | 24.86 |
| 31 | −54.376 | 1.00 | 1.84666 | 23.8 | 25.48 |
| 32 | −158.660 | 40.0 | | | 26.08 |
| Image Surface | ∞ | | | | |

ASPHERIC DATA

22nd Surface
K = 0.00000e+00 A4 = 1.34215e−06 A6 = 4.95860e−09 A8 = −7.44395e−11
A10 = 5.04803e−13

VARIOUS DATA

| | |
|---|---|
| Focal Length | 110.22 |
| Fno | 4.12 |
| Half Angle of View (°) | 11.11 |
| Image Height | 21.64 |
| Overall Lens Length | 120.00 |
| BF | 40.00 |

| Imaging Magnification | Infinity | −0.5 |
|---|---|---|
| d12 | 2.25 | 10.06 |
| d15 | 11.83 | 4.03 |
| d21 | 1.31 | 16.68 |
| d24 | 2.43 | 3.87 |
| d28 | 17.22 | 0.39 |

| | | | | |
|---|---|---|---|---|
| Entrance Pupil Position | 48.66 | 49.04 | 55.58 | 52.54 |
| Exit Pupil Position | −38.10 | −37.99 | −33.06 | −36.21 |
| Front Principal Point Position | 3.33 | 2.22 | −21.58 | −9.87 |
| Rear Principal Point Position | −70.22 | −70.70 | −70.79 | −73.15 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 56.98 | 19.13 | 1.15 | −12.22 |
| 2 | 13 | −47.77 | 3.18 | 2.35 | 0.59 |
| 3 | 16 | 50.09 | 8.72 | 6.51 | −0.60 |
| 4 | 22 | −61.97 | 1.55 | 0.75 | −0.28 |
| 5 | 25 | 301.75 | 4.12 | −1.24 | −4.08 |
| 6 | 29 | 523.87 | 8.25 | −17.08 | −22.91 |

SINGLE LENS DATA

| Lens | Starting Surface | Focal Length |
|---|---|---|
| 1 | 1 | 75.57 |
| 2 | 4 | 65.80 |
| 3 | 6 | −43.89 |
| 4 | 8 | −125.44 |
| 5 | 9 | 115.58 |
| 6 | 11 | 91.07 |
| 7 | 13 | −28.04 |
| 8 | 14 | 62.69 |
| 9 | 17 | 151.50 |
| 10 | 19 | −96.35 |
| 11 | 20 | 42.16 |
| 12 | 22 | −8762.17 |
| 13 | 23 | −62.43 |
| 14 | 25 | 68.90 |
| 15 | 27 | −88.32 |
| 16 | 29 | 85.70 |
| 17 | 31 | −98.14 |

### Numerical Example 5

UNIT: mm
SURFACE DATA

| Surface No | r | d | nd | νd | Effective Diameter |
|---|---|---|---|---|---|
| 1 | ∞ | 1.50 | | | 37.31 |
| 2 | 163.453 | 4.21 | 1.95375 | 32.3 | 36.36 |
| 3 | −105.073 | 0.61 | | | 35.85 |
| 4 | 38.687 | 3.58 | 1.49700 | 81.5 | 30.22 |
| 5 | 85.523 | 2.77 | | | 28.52 |
| 6 | −73.018 | 1.20 | 1.85478 | 24.8 | 28.25 |
| 7 | 54.590 | 1.98 | | | 26.47 |
| 8 | 56.800 | 1.20 | 1.89986 | 32.7 | 25.82 |
| 9 | 39.963 | 3.62 | 1.49700 | 81.5 | 25.11 |
| 10 | −275.683 | 0.97 | | | 24.66 |
| 11 | 45.194 | 3.77 | 1.49700 | 81.5 | 23.08 |
| 12 | −73.681 | (Variable) | | | 22.29 |
| 13 | −100.917 | 1.40 | 1.53864 | 66.3 | 20.94 |
| 14 | 24.305 | 0.31 | 1.53110 | 55.9 | 19.87 |
| 15* | 26.331 | (Variable) | | | 19.85 |
| 16 (Aperture Stop) | ∞ | 2.46 | | | 20.02 |
| 17 | 85.791 | 2.56 | 1.95375 | 32.3 | 20.04 |
| 18 | −82.798 | 1.63 | | | 19.89 |
| 19 | −149.009 | 0.50 | 1.68444 | 35.1 | 19.00 |
| 20 | 94.572 | 1.62 | 1.84666 | 23.8 | 18.73 |
| 21 | −103.440 | (Variable) | | | 18.57 |
| 22* | −96.988 | 0.35 | 1.53110 | 55.9 | 15.29 |
| 23 | −49.415 | 1.40 | 1.48741 | 70.3 | 15.28 |
| 24 | 31.005 | (Variable) | | | 14.34 |
| 25 | 50.006 | 6.09 | 1.48749 | 70.2 | 22.14 |
| 26 | −21.690 | 0.15 | | | 22.41 |
| 27 | −22.642 | 1.00 | 1.84667 | 23.8 | 22.29 |
| 28 | −357.990 | 36.15 | | | 23.48 |
| Image Surface | ∞ | | | | |

ASPHERIC DATA

15th Surface
K = 0.00000e+00 A4 = −4.15065e−06 A6 = 3.96039e−10 A8 = −8.09148e−11
A10 = 3.51171e−13
22nd Surface
K = 0.00000e+00 A4 = 1.20126e−06 A6 = 4.49914e−08 A8 = −7.71502e−10
A10 = 4.64740e−12

VARIOUS DATA

| | |
|---|---|
| Focal Length | 110.67 |
| Fno | 4.12 |
| Half Angle of View (°) | 11.06 |
| Image Height | 21.64 |
| Overall Lens Length | 125.00 |
| BF | 36.15 |

| Imaging Magnification | Infinity | −1.0 |
|---|---|---|
| d12 | 1.61 | 18.70 |
| d15 | 20.89 | 3.89 |
| d21 | 5.58 | 19.15 |
| d24 | 15.88 | 2.27 |

| | | | | | |
|---|---|---|---|---|---|
| Entrance Pupil Position | 67.40 | 68.03 | 113.75 | 76.21 | 87.92 |
| Exit Pupil Position | −27.41 | −27.39 | −21.86 | −26.46 | −25.21 |
| Front Principal Point Position | −14.62 | −15.26 | −35.08 | −20.72 | −25.40 |
| Rear Principal Point Position | −74.52 | −74.51 | −57.47 | −72.23 | −68.36 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 50.76 | 25.40 | 10.22 | −10.76 |
| 2 | 13 | −38.55 | 1.71 | 0.88 | −0.23 |
| 3 | 16 | 36.62 | 8.77 | 3.95 | −2.70 |
| 4 | 22 | −49.02 | 1.75 | 0.89 | −0.27 |
| 5 | 25 | −467.70 | 7.23 | 25.56 | 19.68 |

SINGLE LENS DATA

| Lens | Starting Surface | Focal Length |
|---|---|---|
| 1 | 1 | 67.58 |
| 2 | 4 | 138.62 |
| 3 | 6 | −36.39 |
| 4 | 8 | −155.05 |
| 5 | 9 | 70.50 |
| 6 | 11 | 56.96 |
| 7 | 13 | −36.22 |
| 8 | 14 | 564.74 |
| 9 | 17 | 44.51 |
| 10 | 19 | −84.46 |
| 11 | 20 | 58.57 |
| 12 | 22 | 189.20 |
| 13 | 23 | −38.87 |
| 14 | 25 | 31.92 |
| 15 | 27 | −28.59 |

### Numerical Example 6

UNIT: mm
SURFACE DATA

| Surface No | r | d | nd | νd | Effective Diameter |
|---|---|---|---|---|---|
| 1 | ∞ | 1.50 | | | 32.98 |
| 2 | 797.447 | 1.63 | 1.95375 | 32.3 | 32.39 |
| 3 | −628.379 | 0.13 | | | 32.13 |
| 4 | 122.066 | 3.78 | 1.49700 | 81.5 | 31.52 |
| 5 | −139.354 | 0.24 | | | 30.78 |
| 6 | −108.510 | 1.20 | 1.85478 | 24.8 | 30.79 |
| 7 | −269.097 | 0.99 | | | 30.35 |
| 8 | 70.829 | 1.20 | 1.62817 | 39.1 | 28.77 |
| 9 | 34.532 | 4.96 | 1.49700 | 81.5 | 27.49 |
| 10 | −177.926 | 0.97 | | | 26.75 |
| 11 | 57.960 | 2.51 | 1.49700 | 81.5 | 25.94 |
| 12 | 1178.009 | (Variable) | | | 25.57 |
| 13 | −714.730 | 1.20 | 1.80810 | 46.5 | 23.52 |
| 14 | 63.755 | 0.94 | 1.92286 | 20.9 | 22.81 |
| 15 | 73.009 | (Variable) | | | 22.57 |
| 16 (Aperture Stop) | ∞ | (Variable) | | | 17.34 |
| 17 | −69.477 | 1.00 | 1.69597 | 50.9 | 16.79 |
| 18 | 54.133 | 2.88 | | | 16.63 |
| 19 | 98.106 | 1.63 | 1.89970 | 30.6 | 16.85 |
| 20 | −37.055 | 1.00 | 1.61562 | 65.2 | 16.84 |
| 21 | 57.300 | (Variable) | | | 16.51 |
| 22 | 106.086 | 5.76 | 1.49692 | 81.6 | 33.16 |
| 23 | −50.706 | 0.20 | | | 33.62 |
| 24 | 68.722 | 4.20 | 1.48749 | 70.2 | 34.08 |
| 25 | −94.099 | 12.91 | | | 34.03 |
| 26 | −44.117 | 1.00 | 1.84667 | 23.8 | 29.89 |
| 27 | 250.000 | 33.73 | | | 30.49 |
| Image Surface | ∞ | | | | |

VARIOUS DATA

| | |
|---|---|
| Focal Length | 115.85 |
| Fno | 4.12 |
| Half Angle of View (°) | 10.58 |
| Image Height | 21.64 |
| Overall Lens Length | 140.00 |
| BF | 33.73 |

| Imaging Magnification | Infinity | −1.0 |
|---|---|---|
| d12 | 2.12 | 17.95 |
| d15 | 18.64 | 2.84 |
| d16 | 1.59 | 32.34 |
| d21 | 32.10 | 1.34 |

| | | | | | |
|---|---|---|---|---|---|
| Entrance Pupil Position | 57.32 | 57.73 | 73.14 | 62.24 | 67.58 |
| Exit Pupil Position | −50.36 | −50.31 | −36.26 | −48.47 | −45.73 |
| Front Principal Point Position | 13.56 | 11.45 | −52.10 | −11.44 | −27.35 |
| Rear Principal Point Position | −82.12 | −83.29 | −73.90 | −90.82 | −89.83 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 48.34 | 19.11 | 8.03 | −5.90 |
| 2 | 13 | −83.51 | 2.14 | 1.12 | −0.04 |
| Aperture Stop | 16 | ∞ | 0.00 | 0.00 | −0.00 |
| 3 | 17 | −60.66 | 6.51 | −0.29 | −5.23 |
| 4 | 22 | 77.70 | 24.06 | −24.40 | −32.99 |

SINGLE LENS DATA

| Lens | Starting Surface | Focal Length |
|---|---|---|
| 1 | 1 | 368.69 |
| 2 | 4 | 131.56 |
| 3 | 6 | −213.46 |
| 4 | 8 | −108.66 |
| 5 | 9 | 58.64 |
| 6 | 11 | 122.56 |
| 7 | 13 | −72.38 |
| 8 | 14 | 519.69 |
| 9 | 17 | −43.57 |
| 10 | 19 | 30.07 |
| 11 | 20 | −36.41 |
| 12 | 22 | 69.89 |
| 13 | 24 | 82.17 |
| 14 | 26 | −44.22 |

### Numerical Example 7

UNIT: mm
SURFACE DATA

| Surface No | r | d | nd | νd | Effective Diameter |
|---|---|---|---|---|---|
| 1 | ∞ | 1.50 | | | 39.03 |
| 2 | 258.701 | 3.55 | 1.95375 | 32.3 | 38.16 |
| 3 | −136.563 | 0.11 | | | 37.74 |
| 4 | 47.785 | 4.70 | 1.49700 | 81.5 | 33.75 |
| 5 | 398.844 | 1.13 | | | 32.11 |
| 6 | −160.130 | 1.20 | 1.85478 | 24.8 | 32.10 |
| 7 | 54.937 | 1.89 | | | 30.00 |
| 8 | 53.346 | 1.20 | 1.76052 | 27.2 | 29.14 |
| 9 | 37.404 | 5.02 | 1.49700 | 81.5 | 28.15 |
| 10 | −137.507 | 0.97 | | | 27.42 |
| 11 | 38.276 | 2.93 | 1.49700 | 81.5 | 24.33 |
| 12 | 288.818 | (Variable) | | | 23.40 |
| 13 | −215.253 | 0.80 | 1.74322 | 53.0 | 20.96 |
| 14 | 21.029 | 1.85 | 1.92286 | 20.9 | 19.03 |
| 15 | 31.168 | (Variable) | | | 18.43 |
| 16 (Aperture Stop) | ∞ | 0.60 | | | 17.51 |
| 17 | 132.072 | 2.55 | 1.95375 | 32.3 | 17.46 |
| 18 | −40.188 | 0.20 | | | 17.34 |
| 19 | −34.627 | 1.04 | 1.48749 | 70.2 | 17.32 |
| 20 | −32.067 | 1.10 | 1.84666 | 23.8 | 17.09 |
| 21 | −45.708 | (Variable) | | | 16.97 |
| 22* | −98.884 | 0.05 | 1.53110 | 55.9 | 16.15 |
| 23 | −229.821 | 0.90 | 1.53550 | 64.6 | 16.09 |
| 24 | 41.557 | (Variable) | | | 15.64 |
| 25 | 52.989 | 4.15 | 1.48749 | 70.2 | 20.27 |
| 26 | −34.230 | 8.84 | | | 20.61 |
| 27 | −27.147 | 1.00 | 1.87973 | 27.6 | 20.73 |
| 28 | −364.618 | 30.53 | | | 21.85 |
| Image Surface | ∞ | | | | |

ASPHERIC DATA

22nd Surface
K = 0.00000e+00 A4 = −8.06792e−07 A6 = 3.16734e−08 A8 = −3.66331e−10
A10 = 1.23432e−12

VARIOUS DATA

| | |
|---|---|
| Focal Length | 105.18 |
| Fno | 4.12 |
| Half Angle of View (°) | 11.62 |
| Image Height | 21.64 |
| Overall Lens Length | 118.00 |
| BF | 30.53 |

| Imaging Magnification | Infinity | −1.0 |
|---|---|---|
| d12 | 2.46 | 19.56 |
| d15 | 20.29 | 3.33 |
| d21 | 1.23 | 15.58 |
| d24 | 16.18 | 1.77 |

| | | | | | |
|---|---|---|---|---|---|
| Entrance Pupil Position | 69.30 | 70.16 | 115.26 | 79.73 | 91.00 |
| Exit Pupil Position | −21.80 | −21.77 | −18.96 | −21.39 | −20.74 |
| Front Principal Point Position | −36.93 | −36.97 | −44.72 | −37.80 | −39.69 |
| Rear Principal Point Position | −74.65 | −74.20 | −51.66 | −68.80 | −62.93 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 49.34 | 24.20 | 8.91 | −9.63 |
| 2 | 13 | −40.97 | 2.65 | 1.56 | 0.14 |
| 3 | 16 | 41.79 | 5.48 | 2.15 | −1.29 |
| 4 | 22 | −54.59 | 0.95 | 0.44 | −0.18 |
| 5 | 25 | −34354.01 | 13.99 | 10194.75 | 7852.49 |

SINGLE LENS DATA

| Lens | Starting Surface | Focal Length |
|---|---|---|
| 1 | 1 | 94.13 |
| 2 | 4 | 108.75 |
| 3 | 6 | −47.73 |
| 4 | 8 | −170.11 |
| 5 | 9 | 59.73 |
| 6 | 11 | 88.44 |
| 7 | 13 | −25.74 |
| 8 | 14 | 64.41 |
| 9 | 17 | 32.54 |
| 10 | 19 | 785.54 |
| 11 | 20 | −131.79 |
| 12 | 22 | −326.84 |
| 13 | 23 | −65.64 |
| 14 | 25 | 43.34 |
| 15 | 27 | −33.39 |

### Numerical Example 8

UNIT: mm
SURFACE DATA

| Surface No | r | d | nd | νd | Effective Diameter |
|---|---|---|---|---|---|
| 1 | ∞ | 1.50 | | | 33.46 |
| 2 | 61.774 | 1.20 | 1.85478 | 24.8 | 30.73 |
| 3 | 24.871 | 8.22 | | | 28.30 |
| 4 | 65.249 | 2.09 | 1.50159 | 72.5 | 27.72 |
| 5 | −959.980 | 4.61 | | | 27.61 |
| 6 | 73.831 | 1.20 | 1.89295 | 20.4 | 25.60 |
| 7 | 42.463 | 4.59 | 1.49700 | 81.5 | 24.92 |
| 8 | −67.565 | 0.97 | | | 24.47 |
| 9 | 46.549 | 3.96 | 1.49700 | 81.5 | 22.27 |
| 10 | −45.571 | (Variable) | | | 21.49 |
| 11 | −43.685 | 0.80 | 1.73012 | 54.6 | 18.62 |
| 12 | 16.537 | 2.29 | 1.92286 | 20.9 | 16.76 |
| 13 | 31.284 | (Variable) | | | 16.19 |
| 14 (Aperture Stop) | ∞ | 0.09 | | | 17.29 |
| 15 | 47.659 | 2.85 | 1.95375 | 32.3 | 17.43 |
| 16 | −61.905 | 0.60 | | | 17.28 |
| 17 | 164.946 | 3.72 | 1.54550 | 65.7 | 16.58 |
| 18 | −19.797 | 1.10 | 1.74431 | 27.4 | 15.93 |
| 19 | −108.737 | (Variable) | | | 15.43 |
| 20* | 67.363 | 0.29 | 1.53110 | 55.9 | 13.30 |
| 21 | 377.182 | 0.90 | 1.81350 | 44.0 | 13.28 |
| 22 | 21.019 | (Variable) | | | 12.71 |
| 23 | 38.634 | 4.38 | 1.48749 | 70.2 | 18.49 |
| 24 | −23.053 | 11.19 | | | 18.89 |
| 25 | −28.319 | 0.50 | 1.84668 | 23.8 | 19.55 |
| 26 | 91.838 | 24.18 | | | 20.57 |
| Image Surface | ∞ | | | | |

ASPHERIC DATA

20th Surface
K = 0.00000e+00 A4 = −1.88646e−05 A6 = 1.83998e−07 A8 = −2.54179e−09
A10 = 1.36793e−11

VARIOUS DATA

| | |
|---|---|
| Focal Length | 52.00 |
| Fno | 4.12 |
| Half Angle of View (°) | 22.59 |
| Image Height | 21.64 |
| Overall Lens Length | 115.00 |
| BF | 24.18 |

| Imaging Magnification | Infinity | −1.0 |
|---|---|---|
| d10 | 1.77 | 18.87 |
| d13 | 20.19 | 3.13 |
| d19 | 3.97 | 9.26 |
| d22 | 7.82 | 2.51 |

| | | | | | |
|---|---|---|---|---|---|
| Entrance Pupil Position | 34.46 | 34.80 | 53.89 | 38.82 | 43.72 |
| Exit Pupil Position | −17.37 | −17.33 | −15.94 | −16.88 | −16.43 |
| Front Principal Point Position | 21.39 | 20.75 | −10.47 | 13.35 | 4.93 |
| Rear Principal Point Position | −27.82 | −28.37 | −36.58 | −33.27 | −36.18 |

Lens Unit Data

| Lens | Starting | Focal | Lens Structure | Front Principal | Rear Principal |
|---|---|---|---|---|---|
| Unit | Surface | Length | Length | Point Position | Point Position |
| 1 | 1 | 35.50 | 28.34 | 24.34 | 7.12 |
| 2 | 11 | −28.68 | 3.09 | 1.24 | −0.39 |
| 3 | 14 | 28.38 | 8.37 | 0.65 | −4.56 |
| 4 | 20 | −33.50 | 1.19 | 0.89 | 0.19 |
| 5 | 23 | 102.20 | 16.07 | −47.69 | −41.92 |

SINGLE LENS DATA

| Lens | Starting Surface | Focal Length |
|---|---|---|
| 1 | 1 | −49.45 |
| 2 | 4 | 121.89 |
| 3 | 6 | −113.98 |
| 4 | 7 | 53.20 |
| 5 | 9 | 47.00 |
| 6 | 11 | −16.34 |
| 7 | 12 | 35.38 |
| 8 | 15 | 28.60 |
| 9 | 17 | 32.64 |
| 10 | 18 | −32.69 |
| 11 | 20 | 154.37 |
| 12 | 21 | −27.39 |
| 13 | 23 | 30.32 |
| 14 | 25 | −25.52 |

Table 1 below summarizes various values in each numerical example.

TABLE 1

| | | NUMERICAL EXAMPLE | | | | | | | |
|---|---|---|---|---|---|---|---|---|---|
| INEQUALITY | | 1 | 2 | 3 | 4 | 5 | 6 | 7 | 8 |
| (1) | dF/L | 0.032 | 0.049 | 0.096 | 0.074 | 0.028 | 0.062 | 0.030 | 0.037 |
| (2) | \|f1/fL\| | 0.177 | 0.887 | 0.195 | 0.109 | 0.109 | 0.622 | 0.001 | 0.347 |
| (3) | \|(1 − βf²)βr²\| | 3.200 | 4.846 | 2.389 | 0.340 | 4.001 | 1.596 | 3.200 | 3.500 |
| (4) | L/f | 1.123 | 1.333 | 1.091 | 1.089 | 1.129 | 1.208 | 1.122 | 2.212 |
| (5) | f1/f | 0.472 | 1.041 | 0.534 | 0.517 | 0.459 | 0.417 | 0.469 | 0.683 |
| (6) | \|f2/f\| | 0.402 | 2.258 | 0.467 | 0.433 | 0.348 | 0.721 | 0.390 | 0.551 |
| (7) | \|f3/f\| | 0.421 | 0.646 | 0.471 | 0.454 | 0.331 | 0.524 | 0.397 | 0.546 |
| (8) | \|f4/f\| | 0.492 | 0.368 | 0.651 | 0.562 | 0.443 | 0.671 | 0.519 | 0.644 |
| (9) | \| β \| | 1.000 | 1.000 | 0.500 | 0.500 | 1.000 | 1.000 | 1.000 | 1.000 |

| INEQUAL- | NUMERICAL EXAMPLE | | | | | | | |
|---|---|---|---|---|---|---|---|---|
| ITY | 1 | 2 | 3 | 4 | 5 | 6 | 7 | 8 |
| dF | 3.941 | 5.852 | 11.535 | 8.853 | 3.461 | 8.647 | 3.598 | 4.284 |
| L | 125.000 | 120.000 | 120.000 | 120.000 | 125.000 | 140.000 | 118.000 | 115.000 |
| f1 | 52.511 | 93.730 | 58.707 | 56.982 | 50.762 | 48.345 | 49.345 | 35.499 |
| fL | 296.902 | 105.719 | 301.703 | 523.874 | −467.696 | 77.703 | −34354.009 | 102.202 |
| β f | 3.075 | 3.827 | 2.131 | 0.749 | 2.176 | 8.995 | 2.523 | 5.390 |
| β r | 0.615 | 0.596 | 0.821 | 0.880 | 1.035 | 0.141 | 0.772 | 0.353 |
| f | 111.293 | 90.000 | 110.000 | 110.217 | 110.673 | 115.849 | 105.183 | 52.000 |
| f1 | 52.511 | 93.730 | 58.707 | 56.982 | 50.762 | 48.345 | 49.345 | 35.499 |
| f2 | −44.698 | 203.229 | −51.321 | −47.769 | −38.550 | −83.507 | −40.971 | −28.678 |
| f3 | 46.865 | 58.104 | 51.780 | 50.093 | 36.618 | −60.659 | 41.795 | 28.378 |
| f4 | −54.715 | −33.143 | −71.647 | −61.972 | −49.022 | 77.703 | −54.588 | −33.503 |

### Image Pickup Apparatus

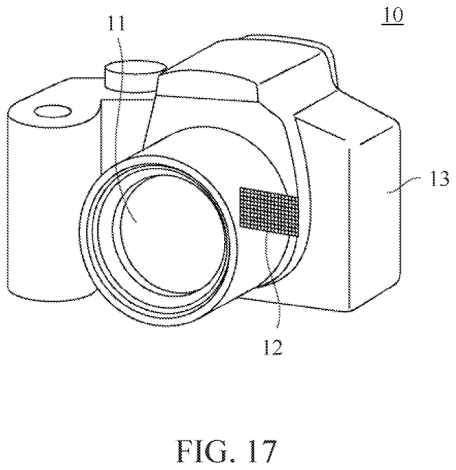

Referring now to FIG. 17, a description will be given of an embodiment of a digital still camera (image pickup apparatus) 10 using the optical system L0 according to each example as an imaging optical system. In FIG. 17, reference numeral 13 denotes a camera body, and reference numeral 11 denotes an imaging optical system that includes one of the optical systems L0 according to Examples 1 to 8. Reference numeral 12 denotes a solid-state image sensor (photoelectric conversion element) such as a CCD sensor or CMOS sensor, which is built in the camera body 13 and configured to receive and photoelectrically convert an optical image formed by the imaging optical system 11. The camera body 13 may be a so-called single-lens reflex camera having a quick turn mirror, or a so-called mirrorless camera without a quick turn mirror. An optical apparatus including the imaging optical system 11 may be attached to the camera body 13, or the optical apparatus including the camera body 13 and the imaging optical system 11 may be integrated so that they are undetachable.

Applying the optical system L0 according to each example to an image pickup apparatus such as a digital still camera can provide an image pickup apparatus having a compact lens.

In the macro lens, this embodiment can reduce the weight and size of the focus lens unit, improve the focusing stop accuracy, increase the focusing speed, and provide a compact and high-performance optical system.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-111958, filed on Jul. 12, 2022, which is hereby incorporated by reference herein in its entirety.

What is claimed is:

1. An optical system comprising, in order from an object side to an image side, a first lens unit, a second lens unit, a third lens unit, and a fourth lens unit,
wherein each distance between adjacent lens units changes during focusing from infinity to a close distance,
wherein the optical system further comprises:
an aperture stop disposed on the image side of the second lens unit;
a final lens unit disposed closest to an image plane in the optical system, the first lens unit and the final lens unit being fixed relative to the image plane during the focusing; and
focus lens units disposed on the object side and the image side of the aperture stop and movable during the focusing,
wherein a focus lens unit closest to the image plane among the focus lens units moves toward the image side during the focusing,
wherein the optical system is configured to increase an absolute value of an imaging magnification at a shortest imaging distance to 0.5 times or higher,
wherein the final lens unit includes a positive lens and a negative lens, and
wherein the following inequalities are satisfied:
0.025<dF/L<0.099
0.1<|f4/f|<0.9
where dF is a sum of distances on an optical axis from a lens surface closest to an object to a lens surface closest to the image plane in each of the focus lens units, L is an overall lens length of the optical system, f4 is a focal length of the fourth lens unit, and f is a focal length of the optical system.

2. The optical system according to claim 1, wherein the following inequality is satisfied:
0.0<|f1/fL|<1.0
where f1 is a focal length of the first lens unit, and fL is a focal length of the final lens unit.

3. The optical system according to claim 1, wherein the following inequality is satisfied:
0.1<|(1−βf²)×βr²|<5.1
where βf is a lateral magnification of the focus lens unit closest to the image plane among the focus lens units, and βr is a combined lateral magnification of all lens units disposed on the image side of the focus lens unit closest to the image plane among the focus lens units.

4. The optical system according to claim 1, wherein the following inequality is satisfied:
0.8<L/f<2.4.

5. The optical system according to claim 1, wherein the following inequality is satisfied:
0.2<f1/f<1.3
where f1 is a focal length of the first lens unit.

6. The optical system according to claim 1, wherein the following inequality is satisfied:
0.1<|f2/f|<2.5
where f2 is a focal length of the second lens unit.

7. The optical system according to claim 1, wherein the following inequality is satisfied:
0.2<|f3/f|<0.8
where f3 is a focal length of the third lens unit.

8. The optical system according to claim 1, wherein each of the focus lens units consists of four lenses or less.

9. The optical system according to claim 1, wherein the final lens unit consists of, in order from the object side to the image side, a positive subunit and a negative subunit.

10. The optical system according to claim 1, wherein the first lens unit has positive refractive power.

11. The optical system according to claim 1, wherein the number of focus lens units disposed on the object side of the aperture stop among the focus lens units is one, and the number of focus lens units disposed on the image side of the aperture stop among the focus lens units is one.

12. The optical system according to claim 1, wherein one of focus lens units disposed on the image side of the aperture stop and closest to the object among the focus lens units has negative refractive power.

13. The optical system according to claim 1, wherein the first lens unit includes a subunit configured to move in a direction including a component orthogonal to the optical axis during image stabilization.

14. The optical system according to claim 1, wherein the optical system consists of, in order from the object side to the image side, the first lens unit, the second lens unit, the aperture stop, the third lens unit, and the fourth lens unit, and
wherein the aperture stop is fixed relative to the image plane during the focusing.

15. The optical system according to claim 1, wherein the optical system consists of, in order from the object side to the image side, the first lens unit, the second lens unit, the third lens unit, and the fourth lens, and a fifth lens unit.

16. The optical system according to claim 1, wherein the optical system consists of, in order from the object side to the image side, the first lens unit, the second lens unit, the third lens unit, the fourth lens, a fifth lens unit, and a sixth lens unit.

17. An image pickup apparatus comprising:
an optical system; and
an image sensor configured to image an object through the optical system,
wherein the optical system includes, in order from an object side to an image side, a first lens unit, a second lens unit, a third lens unit, and a fourth lens unit,
wherein each distance between adjacent lens units changes during focusing from infinity to a close distance,
wherein the optical system further includes:
an aperture stop disposed on the image side of the second lens unit;
a final lens unit disposed closest to an image plane in the optical system, the first lens unit and the final lens unit being fixed relative to the image plane during the focusing; and
focus lens units disposed on the object side and the image side of the aperture stop and movable during the focusing,
wherein a focus lens unit closest to the image plane among the focus lens units moves toward the image side during the focusing,
wherein the optical system is configured to increase an absolute value of an imaging magnification at a shortest imaging distance to 0.5 times or higher,
wherein the final lens unit includes a positive lens and a negative lens, and
wherein the following inequalities are satisfied:
0.025<dF/L<0.099
0.1<|f4/f|<0.9
where dF is a sum of distances on an optical axis from a lens surface closest to an object to a lens surface closest to the image plane in each of the focus lens units, L is an overall lens length of the optical system, f4 is a focal length of the fourth lens unit, and f is a focal length of the optical system.

18. An optical apparatus comprising an optical system,
wherein the optical system is attachable to and detachable from an image pickup apparatus,
wherein the optical system includes, in order from an object side to an image side, a first lens unit, a second lens unit, a third lens unit, and a fourth lens unit,
wherein each distance between adjacent lens units changes during focusing from infinity to a close distance,
wherein the optical system further includes:
an aperture stop disposed on the image side of the second lens unit;
a final lens unit disposed closest to an image plane in the optical system, the first lens unit and the final lens unit being fixed relative to the image plane during the focusing; and
focus lens units disposed on the object side and the image side of the aperture stop and movable during the focusing,
wherein a focus lens unit closest to the image plane among the focus lens units moves toward the image side during the focusing,
wherein the optical system is configured to increase an absolute value of an imaging magnification at a shortest imaging distance to 0.5 times or higher,
wherein the final lens unit includes a positive lens and a negative lens, and
wherein the following inequalities are satisfied:
0.025<dF/L<0.099
0.1<|f4/f|<0.9
where dF is a sum of distances on an optical axis from a lens surface closest to an object to a lens surface closest to the image plane in each of the focus lens units, L is an overall lens length of the optical system, f4 is a focal length of the fourth lens unit, and f is a focal length of the optical system.
